(19) United States
(12) Patent Application Publication
(10) Pub. No.: US 2013/0344507 A1
(43) Pub. Date: Dec. 26, 2013

(54) SYSTEMS AND METHODS FOR SEPARATING COMPONENT MATERIALS OF A SUSPENSION USING IMMUNOMAGNETIC SEPARATION

(71) Applicant: RareCyte, Inc., (US)

(72) Inventors: Jackie Lynn Stilwell, Sammamish, WA (US); Jennifer Chow, Seattle, WA (US); Ron Seubert, Sammamish, WA (US); Arturo Ramirez, Seattle, WA (US); Barry Friemel, Redmond, WA (US); Jon Lundt, Seattle, WA (US); Joshua Nordberg, Bainbridge Island, WA (US)

(73) Assignee: RareCyte, Inc., Seattle, WA (US)

(21) Appl. No.: 13/837,227

(22) Filed: Mar. 15, 2013

Related U.S. Application Data
(60) Provisional application No. 61/618,143, filed on Mar. 30, 2012.

(51) Int. Cl. G01N 1/34

(52) U.S. Cl. CPC G01N 1/34
USPC 435/7.21; 436/177; 422/527; 436/172; 436/501

(57) ABSTRACT

This disclosure is directed to systems and methods for immunomagnetic separation of a target analyte of a suspension from the other component materials of the suspension. The system may be composed of a tube, a magnetizable float, and a magnet. The magnetizable float is configured to propagate or introduce a magnetic field. In one aspect, the magnet is included in the magnetizable float. In another aspect, the magnet is external to the magnetizable float. The system may also include a solution containing a particle to conjugate with the target analyte to form a target analyte-particle complex. The particle is capable of being attracted by the magnetic field or magnetic gradient introduced by the magnet. The target analyte-particle complex may be attracted to the magnetizable float.

### CROSS-REFERENCE TO A RELATED APPLICATION

This application claims the benefit of Provisional Application No. 61/618,143, filed Mar. 30, 2012, which is hereby incorporated by reference in its entirety.

### TECHNICAL FIELD

This disclosure relates generally to immunomagnetic separation and, in particular, to systems and methods for separation of a target analyte of a suspension from the other component materials of the suspension with a magnetic field or magnetic gradient.

### BACKGROUND

Suspensions often include materials of interest that are difficult to detect, extract and isolate for analysis. For instance, whole blood is a suspension of materials in a fluid. The materials include billions of red and white blood cells and platelets in a proteinaceous fluid called plasma. Whole blood is routinely examined for the presence of abnormal organisms or cells, such as fetal cells, endothelial cells, epithelial cells, parasites, bacteria, and inflammatory cells, and viruses, including HIV, cytomegalovirus, hepatitis C virus, and Epstein-Barr virus and nucleic acids. Currently, practitioners, researchers, and those working with blood samples try to separate, isolate, and extract certain components of a peripheral blood sample for examination. Typical techniques used to analyze a blood sample include the steps of smearing a film of blood on a slide and staining the film in a way that enables certain components to be examined by bright field microscopy.

On the other hand, materials of interest composed of particles that occur in very low numbers are especially difficult if not impossible to detect and analyze using many existing techniques. Consider, for instance, circulating tumor cells (“CTCs”), which are cancer cells that have detached from a tumor, circulate in the bloodstream, and may be regarded as seeds for subsequent growth of additional tumors (i.e., metastasis) in different tissues. The ability to accurately detect and analyze CTCs is of particular interest to oncologists and cancer researchers, but CTCs occur in very low numbers in peripheral whole blood samples. For instance, a 7.5 ml sample of peripheral whole blood that contains as few as 3 CTCs is considered clinically relevant in the diagnosis and treatment of a cancer patient. However, detecting even 1 CTC in a 7.5 ml blood sample may be clinically relevant and is equivalent to detecting 1 CTC in a background of about 40-50 billion red and white blood cells. Using existing techniques to find, isolate and extract as few as 3 CTCs of a whole blood sample is extremely time consuming, costly and is extremely difficult to accomplish.

As a result, practitioners, researchers, and those working with suspensions continue to seek systems and methods to more efficiently and accurately detect, isolate and extract target materials of a suspension.

### DESCRIPTION OF THE DRAWINGS

FIGS. 1A-1C show isometric views of example tube and magnetizable float systems.

FIGS. 2A-2D show example magnetizable float

FIG. 3-6 show example magnetizable float.

FIG. 7A shows an exploded view of an example magnetizable float.

FIG. 7B shows an exploded view of an example magnetizable float.

FIG. 7C shows an exploded view of an example magnetizable float.

FIG. 8 shows a flow diagram for separating a target analyte from a suspension.

FIG. 9 shows an example of a tube and magnetizable float system to attract a target analyte-particle complex.

FIG. 10 shows an example of a tube and magnetizable float system to attract a target analyte-particle complex.

FIG. 11 shows an example of a tube and magnetizable float system to attract a target analyte-particle complex.

FIG. 12 shows an imaging process.

FIG. 13A shows a magnetizable float being removed from a tube.

FIG. 13B shows a target analyte being separated from a magnetizable float.

FIG. 14A shows an image of cells using a doubly-conjugated ligand.

FIGS. 14B-14C show images of a cell having been labeled with fluorescent markers and conjugated with particles.

### DETAILED DESCRIPTION

This disclosure is directed to systems and methods for immunomagnetic separation of a target analyte of a suspension from the other component materials of the suspension. The system may be composed of a tube, a magnetizable float, and a magnet. The magnetizable float is configured to propagate or introduce a magnetic field. In one aspect, the magnet is included in the magnetizable float. In another aspect, the magnet is external to the magnetizable float. The system may also include a solution containing a particle to conjugate with the target analyte to form a target analyte-particle complex. The particle is capable of being attracted by the magnetic field or magnetic gradient introduced by the magnet. The target analyte-particle complex may be attracted to the magnetizable float. The systems and methods may allow for positive selection (separating desired material from the other component materials of the suspension) or negative selection (separating the non-desired material from the other component materials of the suspension).

Immunomagnetic separation provides a high level of sensitivity and specificity for rare cells in a biological sample, such as circulating tumor cells (“CTCs”) in blood.

Current immunomagnetic separation technology introduces ferromagnetic particles, which may be attracted by an applied magnetic field, into a blood sample, where antibodies directed to a surface antigen of a cell are coated onto or attached to the magnetic particles. Magnetic separation then occurs, whereby a magnet, having a magnetic field, separates the cells that have attached to or interacted with the ferromagnetic particles from the remaining sample. These systems and methods, however, may attract unwanted cells or analytes that have non-specifically attached to the magnetic particles or interacted with the magnetic particles through processes such as phagocytosis. In doing so, the target analytes of the original sample will still be intermixed with unwanted analytes. Further, not all magnetic bound cells may be removed, as only those magnetically bound cells that are in proximate distance to the magnet will be captured.

Furthermore, some current immunomagnetic separation technologies require that the magnetically separated cells be present in a monolayer for imaging. The cells that are not located in the monolayer are not detected.

A blood sample also includes red blood cells (“RBCs”), which are viscous and may cause interference when removing the magnetically bound cells. The RBCs provide another layer or component which makes imaging the target analytes more difficult.

Separating by density, such as by centrifugation, then introducing a magnetic field to a magnetizable float reduces the prevalence of non-specifically attached magnetic particles and non-target analytes that will be attached to a magnetizable float once magnetized. The unbound magnetic particles will be too far away (due to their respective densities and the prior separation through centrifugation) from the applied or transmitted magnetic field of the magnetizable float. The non-target analytes may have attached to magnetic particles or interacted with the magnetic particles through phagocytosis or other processes. The non-target analytes and non-specifically bound magnetic particles which are attracted to the magnetizable float once it is magnetized may be identified and eliminated from analysis through subsequent imaging. The systems and methods permit more specific detection and characterization through imaging, thereby permitting specific target analytes to be removed from the magnetizable float. Imaging allows for the determination of various characteristics of the analyte that is magnetically attracted and bound to the magnetizable float. Additionally, density separation by centrifugation separates the RBCs from the sample, which makes imaging and attraction more efficient, as there is no concern for imaging through an additional component.

Furthermore, imaging techniques, such as multiple z-stacks or optical axis integration, of this method permit the target analytes to be imaged in a multitude of focal planes. The target analyte may exist at any depth between the magnetizable float and tube for imaging.

Additionally, attracting a target analyte to a magnetizable float with the introduction of a magnetic field may permit using fluidics to wash, fix, permeabilize, and label the target analyte. The force of the magnetic field, being greater than the forces produced by the flow-thru, may hold the target analyte while the flow-thru force will remove the non-target analytes.

It should be understood that “propagate” refers to a characteristic of material, element, structure, component or the like to carry, transmit, or maintain a magnetic field or a magnetic gradient.

It should be understood that “magnetizable” refers to the capability of a material, element, structure, component, or the like to propagate or introduce a magnetic field. “Magnetizable” further includes a material, element, structure, component, or the like which has its own magnetic field or magnetic gradient.

Methods and systems for separating component materials of a suspension are disclosed. The detailed description is organized into two subsections: (1) A general description of various tube and float systems is provided in a first subsection. (2) Examples of methods and systems for separating component materials of suspensions using tube and float systems in which the tube is magnetizable are provided in a second subsection.

### Tube and Float Systems

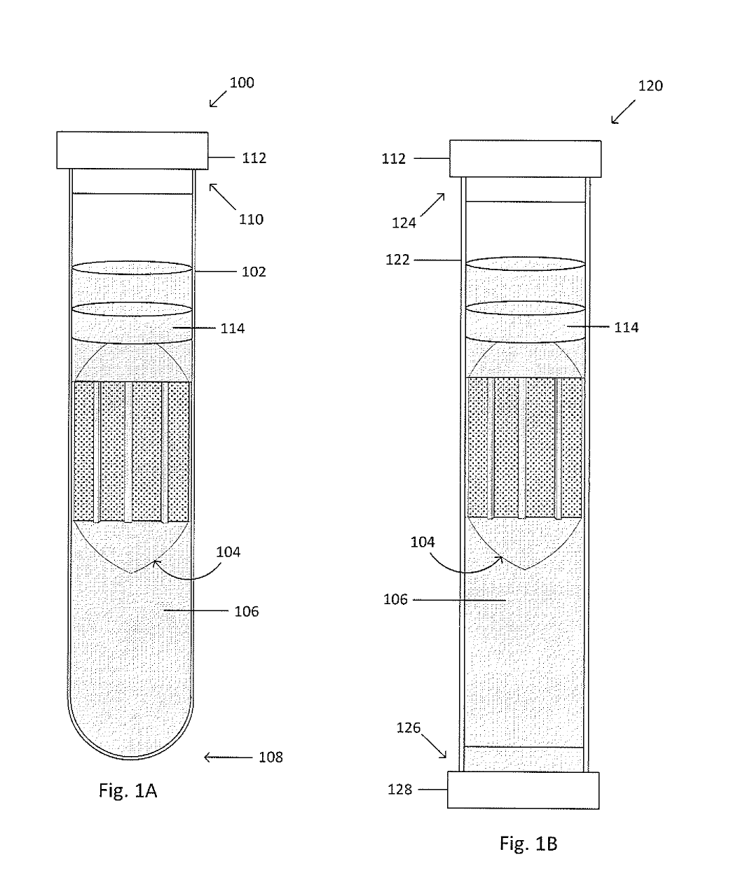

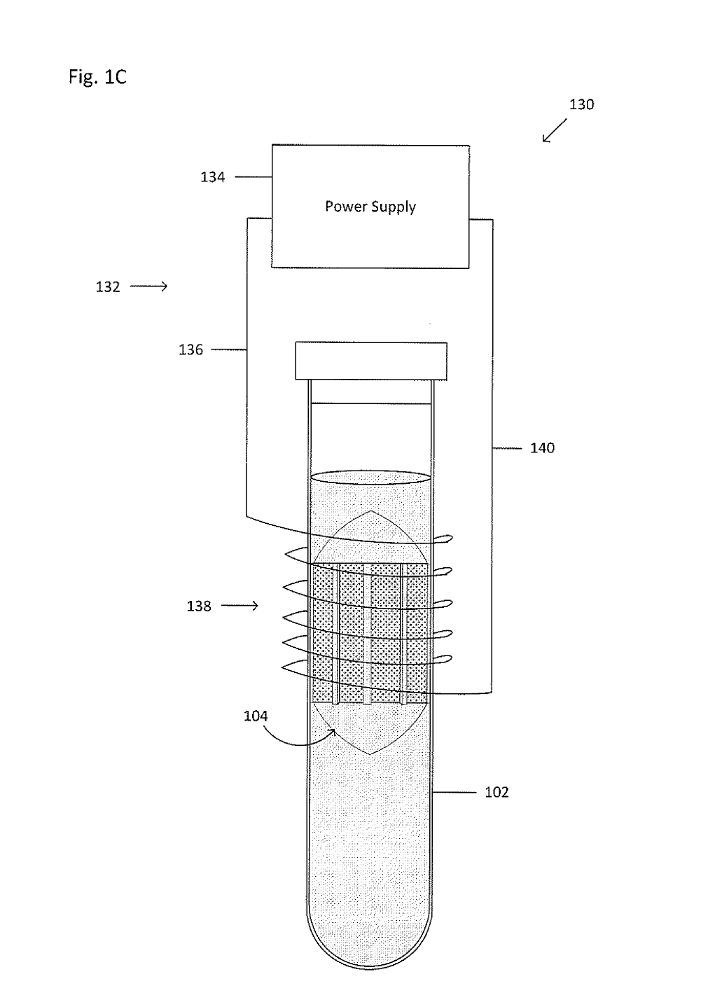

FIG. 1A shows an isometric view of a tube and magnetizable float system 100. The system 100 includes a tube 102 and a magnetizable float 104 suspended within a suspension 106. In FIG. 1A, the tube 102 has a circular cross-section, a first closed end 108, and a second open end 110. The open end 110 is sized to receive a stopper or cap 112. The tube may also have two open ends that are sized to receive stoppers or caps, such as the tube and magnetizable float system 120 shown FIG. 1B. The system 120 is similar to the system 100 except the tube 102 is replaced by a tube 122 that includes two open ends 124 and 126 configured to receive the cap 112 and a cap 128, respectively. The tubes 102 and 122 have a generally cylindrical geometry, but may also have a tapered geometry that widens, narrows, or a combination thereof toward the open ends 110 and 124, respectively. Although the tubes 102 and 122 have a circular cross-section, in other embodiments, the tubes 102 and 122 can have elliptical, square, triangular, rectangular, octagonal, or any other suitable cross-sectional shape that substantially extends the length of the tube. The tubes 102 and 122 can be composed of an opaque, a transparent or a semitransparent material, such as plastic or another suitable material. To introduce a magnetic field or a magnetic gradient to the magnetizable float 104, a magnet 114 may be introduced into the tube 102. The magnetizable float 104 propagates the magnetic field or the magnetic gradient introduced by the magnet 114.

FIG. 1C shows an isometric view of a tube and magnetizable float system 130 for separating a target analyte from a suspension. An electromagnet 132 is external to the tube 102. A power supply 134, such as a battery, supplies power through a first lead 136 and a second lead 140 to a coil 138. Applying current to the coil 138 via the first and second leads 136 and 140 generates a magnetic field. The magnetizable float 104 effectively becomes a core to create the electromagnet to draw a desired material to the sidewall of the tube or to the magnetizable float 104, depending on the direction of the magnetic field or magnetic gradient.

The coil 138 may be comprised of any conductive material, including but not limited to metal, including, but not limited to, aluminum, brass, gold, silver, tin, copper, bronze, chromium, cobalt, nickel, lead, iron, steel, manganese, zinc, and combinations thereof; conductive fabric; conductive thread; conductive foam; conductive wool; conductive tape; and combinations thereof.

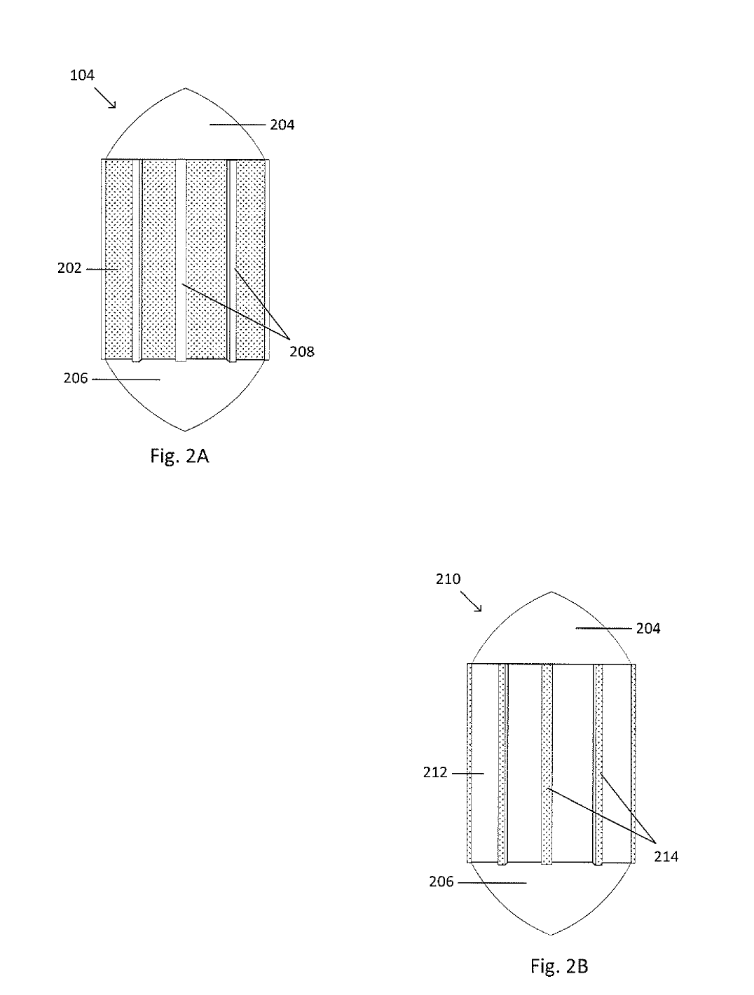

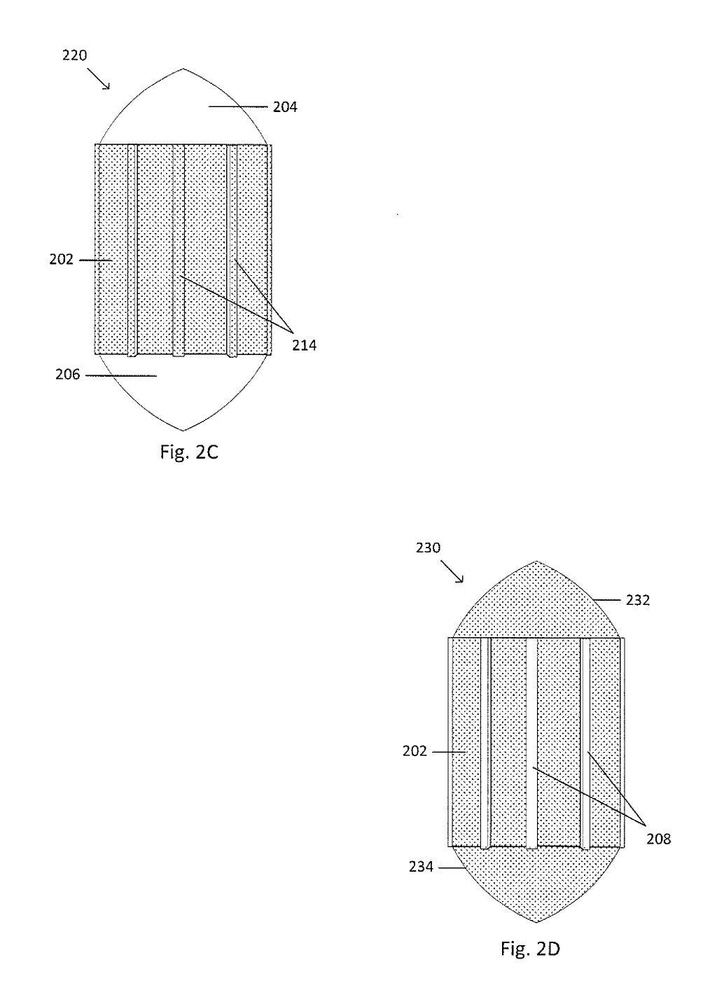

FIG. 2A shows an isometric view of the magnetizable float 104 shown in FIG. 1. The magnetizable float 104 includes a main body 202, teardrop-shaped end caps 204 and 206, and support members 208 radially spaced and axially oriented on the main body 202. The support members 208 engage the inner wall of the tube 102. In alternative embodiments, the number of support members, spline spacing, and spline thickness can each be independently varied. The support members 208 can also be broken or segmented. The main body 202 is sized to have an outer diameter that is less than the inner diameter of the tube 102, thereby defining fluid retention channels between the outer surface of the body 202 and the inner wall of the tube 102. The surfaces of the main body 202 between the support members 208 can be flat, curved or have another suitable geometry. The entire main body 202 may be magnetizable, a portion of the main body 202 may be magnetizable, or many portions of the main body 202 may be magnetizable.

FIG. 2B shows an isometric view of a magnetizable float 210. The magnetizable float 210 is similar to the magnetizable float 104 except the main body 212 is not magnetizable, whereas the support members 214 are magnetizable. FIG. 2C shows an isometric view of a magnetizable float 220. The magnetizable float 220 is similar to the magnetizable float 104 except both the main body 202 and the support members 214 are magnetizable. FIG. 2D shows an isometric view of a magnetizable float 230. The magnetizable float 230 is similar to the magnetizable float 104 except both top and bottom end caps 232 and 234 are also magnetizable.

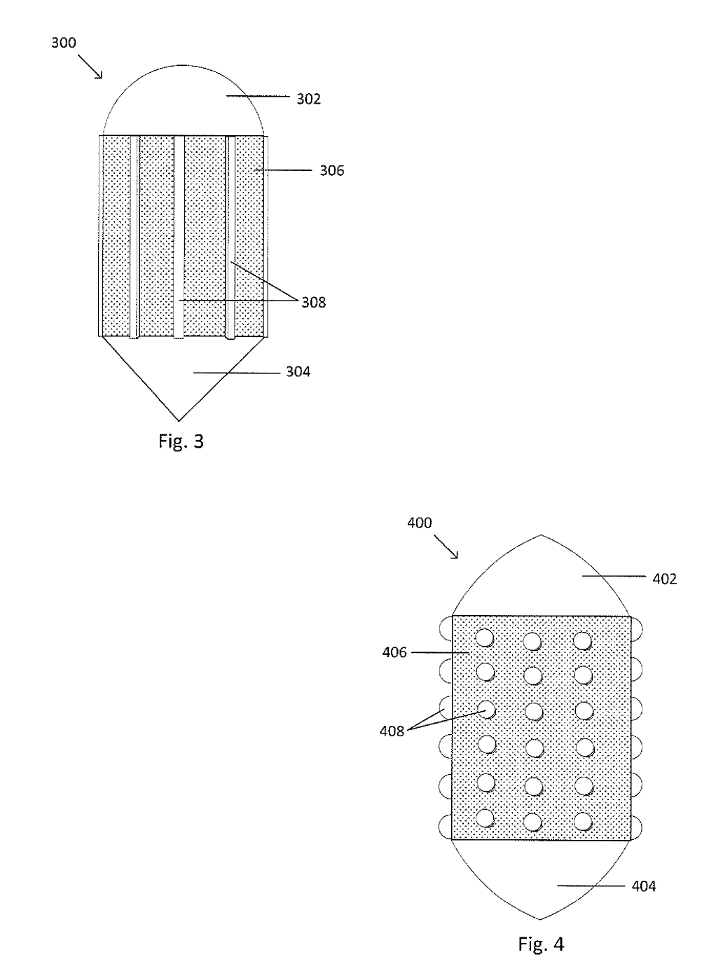

Embodiments include other types of geometric shapes for end caps. FIG. 3 shows an isometric view of an example magnetizable float 300 with a dome-shaped end cap 302 and a cone-shaped end cap 304. A main body 306 of the magnetizable float 300 can include the same support members 308 as the magnetizable float 104. The magnetizable float 300 can also include a teardrop-shaped end cap. The end caps can include other geometric shapes and are not intended to be limited to the shapes described herein.

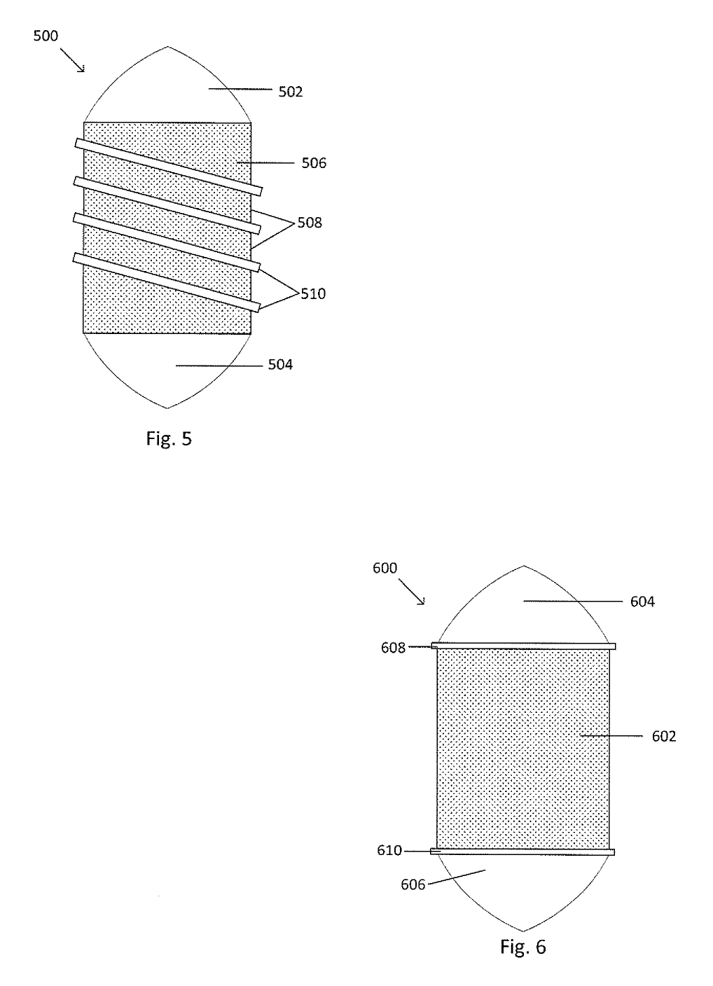

In other embodiments, the main body of the magnetizable float 104 can include a variety of different support structures for separating target materials, supporting the tube wall, or directing the suspension fluid around the magnetizable float during centrifugation. FIGS. 4, 5, and 6 show different types of support members. Embodiments are not intended to be limited to these three types. In FIG. 4, a magnetizable float 400 is similar to the magnetizable float 104 except a main body 402 includes a number of protrusions 404 that provide support for the tube. In alternative embodiments, the number and pattern of protrusions can be varied. In FIG. 5, a magnetizable float 500 is similar to magnetizable float 104, except the magnetizable float 500 includes a single continuous helical structure or ridge 504 that spirals around a main body 502, thereby creating a helical channel 506. In other embodiments, the helical ridge 504 can be rounded or broken or segmented to allow fluid to flow between adjacent turns of the helical ridge 504. In various embodiments, the helical ridge spacing and rib thickness can be independently varied. In FIG. 6, a magnetizable float 600 is similar to the magnetizable float 104 except a main body 602 includes support members 608 and 610 extending circumferentially around the main body 602.

The magnetizable float may include an internal magnet, such as a permanent magnet, an electromagnet, or a switchable magnet. Alternatively, a magnet, such as a permanent magnet, an electromagnet, or a switchable magnet, may be external to the magnetizable float, such that the magnetizable float propagates, transmits, and/or carries the magnet field or magnetic gradient introduced by the magnet.

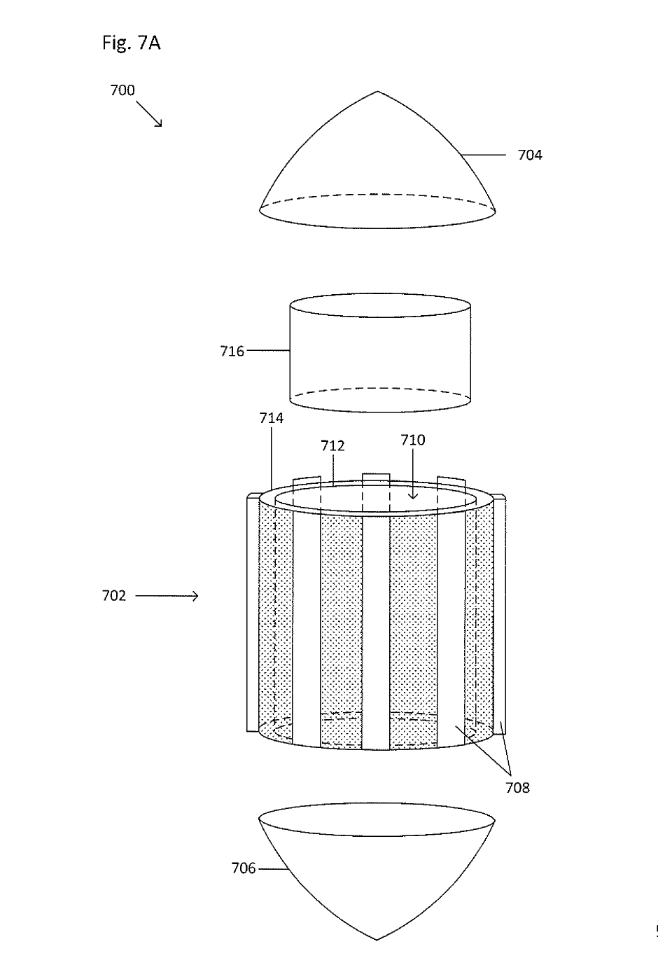

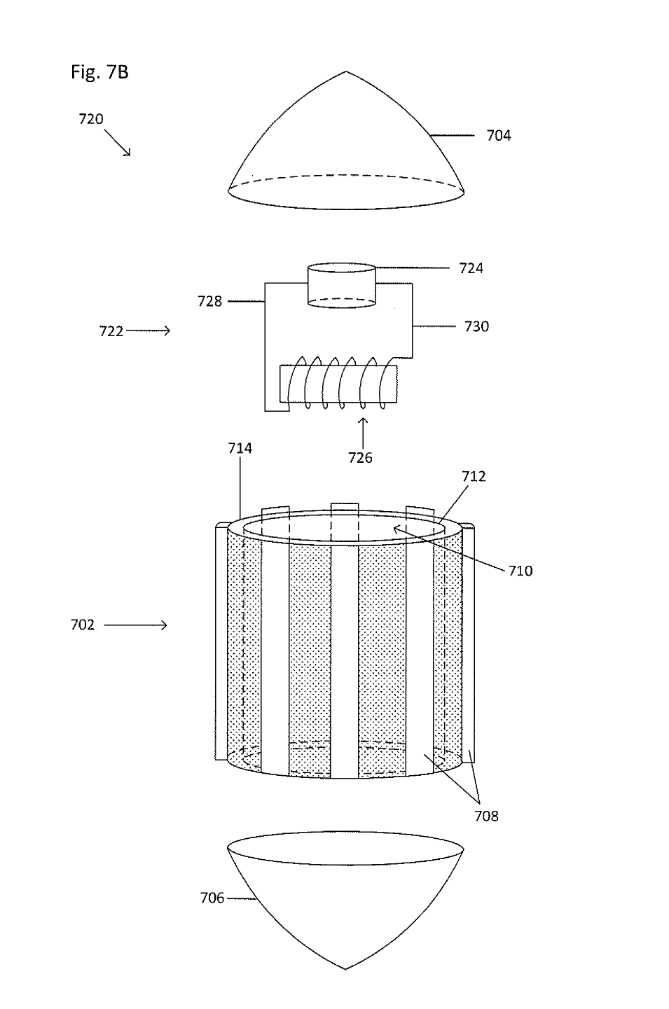

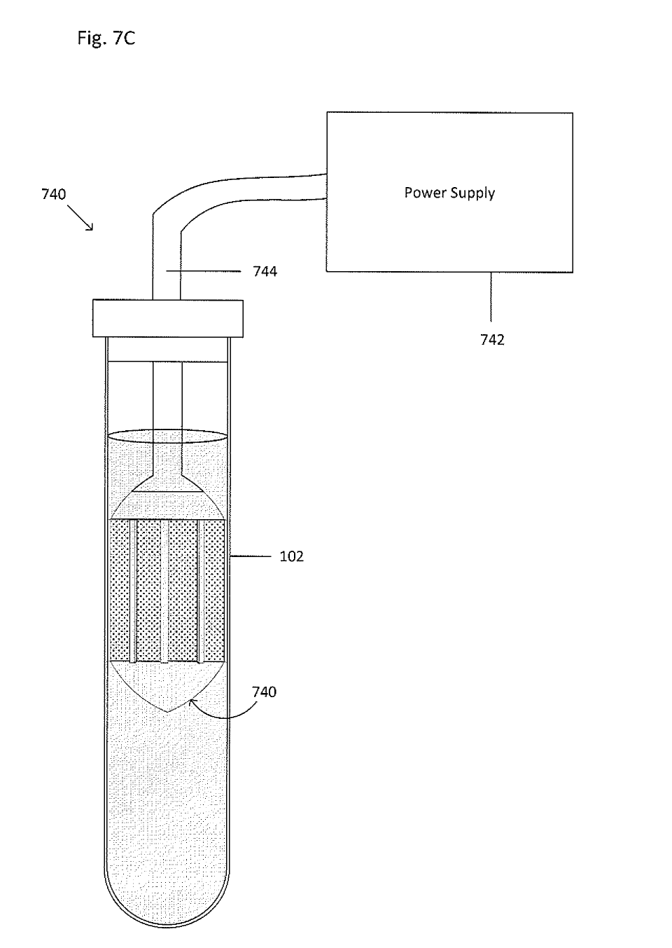

FIG. 7A shows an exploded view of a magnetizable float 700. The magnetizable float 700 is similar to the magnetizable float 100, except the magnetizable float 700 includes a magnetizable core 716 and a central bore 710. The magnetizable float 700 includes a main body 702, teardrop-shaped end caps 704 and 706, and support members 708 radially spaced and axially oriented on the main body 702. The central bore 710 may extend the full length of the main body 702 or may extend a partial length of the main body 702. The main body 702 includes an inner wall 712 and an outer wall 714. The magnetizable float 700 includes a magnetizable core 716 sized and shaped to fit within the central bore 710. The magnetizable core 716 may be a magnet or may be composed of a magnetizable material. When the magnetizable core 716 is a magnet, the magnetizable core 716 may introduce a magnetic field or a magnetic gradient to a tube and magnetizable float system. The main body 702 may be magnetizable, such as by a magnetizable coating or being composed of a magnetizable material, so as to carry, propagate, or transmit the magnetic field or the magnetic gradient introduced by the magnetizable core 716. Alternatively, the main body 702 may not be coated with or composed of a magnetizable material, as the magnetizable core 716 creates the magnetic field or a magnetic gradient.

When the magnetizable core is not a magnet, the magnetizable core may be composed of a metal, including, but not limited to, aluminum, brass, gold, silver, tin, copper, bronze, chromium, cobalt, nickel, lead, iron, steel, manganese, zinc, and combinations thereof.

FIG. 7B shows a magnetizable float 720. The magnetizable float 720 is similar to the magnetizable float 700, except that the magnetizable float 720 includes an electromagnet 722. The electromagnet 722 is configured to fit within the central bore 710. The electromagnet 722 includes a power supply 724, such as a battery, connected to a coil 726 via a first lead 728 and a second lead 730. The power supply 724 may be activated before or after the electromagnet 722 is inserted into the central bore 710. The power supply 724 may be activated via a switch (not shown). The switch may be located within the electromagnet loop, on an outer portion of the main body 702, or on one of the end caps 704 and 706. Alternatively, the power supply 724 may be activated wirelessly. Alternatively, the coil may be located inside of the inner wall 712, on the outside of the outer wall 714, or embedded between the inner wall 712 and the outer wall 714. The power supply 724 fits within the central bore 710 and connects to the coil 742 via a first lead and a second lead.

FIG. 7C shows a magnetizable float 740. The magnetizable float 740 is similar to the magnetizable float 720, except that first and second leads (not shown) are included in an external lead 744. The external lead 744 includes leads to a coil (not shown) in, embedded within, or around the magnetizable float 740 from a power supply 742 that is external to the tube 102.

The magnetizable float can be composed of a variety of different materials. The magnetizable float can be composed of a metal, including, but not limited to, aluminum, brass, gold, silver, tin, copper, bronze, chromium, cobalt, nickel, lead, iron, steel, manganese, zinc, neodymium, and combinations thereof The magnetizable float can be composed of a organic or inorganic materials; ferrous plastics; sintered metal; machined metal; and plastic materials, such as polyoxymethylene (“Delrin®”), polystyrene, acrylonitrile butadiene styrene (“ABS”) copolymers, aromatic polycarbonates, aromatic polyesters, carboxymethylcellulose, ethyl cellulose, ethylene vinyl acetate copolymers, nylon, polyacetals, polyacetates, polyacrylonitrile and other nitrile resins, polyacrylonitrile-vinyl chloride copolymer, polyamides, aromatic polyamides (“aramids”), polyamide-imide, polyarylates, polyarylene oxides, polyarylene sulfides, polyarylsulfones, polybenzimidazole, polybutylene terephthalate, polycarbonates, polyester, polyester imides, polyether sulfones, polyetherimides, polyetherketones, polyetheretherketones, polyethylene terephthalate, polyimides, polymethacrylate, polyolefins (e.g., polyethylene, polypropylene), polyallomers, polyoxadiazole, polyparaxylene, polyphenylene oxides (PPO), modified PPOs, polystyrene, polysulfone, fluorine containing polymer such as polytetrafluoroethylene, polyurethane, polyvinyl acetate, polyvinyl alcohol, polyvinyl halides such as polyvinyl chloride, polyvinyl chloride-vinyl acetate copolymer, polyvinyl pyrrolidone, polyvinylidene chloride, specialty polymers, polystyrene, polycarbonate, polypropylene, acrylonitrite butadiene-styrene copolymer, butyl rubber, ethylene propylene diene monomer, others, and combinations thereof.

When the magnetizable float includes the magnetizable coating, the magnetizable coating may be composed of a metal, including, but not limited to, aluminum, brass, gold, silver, tin, copper, bronze, chromium, cobalt, nickel, lead, iron, steel, manganese, zinc, neodymium, and combinations thereof.

The support members may be included during the molding, forming or machining processes or added after the molding, forming and machining processes are complete.

The tube may have a sidewall and a first diameter, the sidewall being elastically radially expandable to a second diameter in response to an axial load, pressure due to centrifugation, or internally-introduced pressure, the second diameter being sufficiently large to permit axial movement of the magnetizable float in the tube during centrifugation.

### Methods and Systems for Separating Components of a Suspension

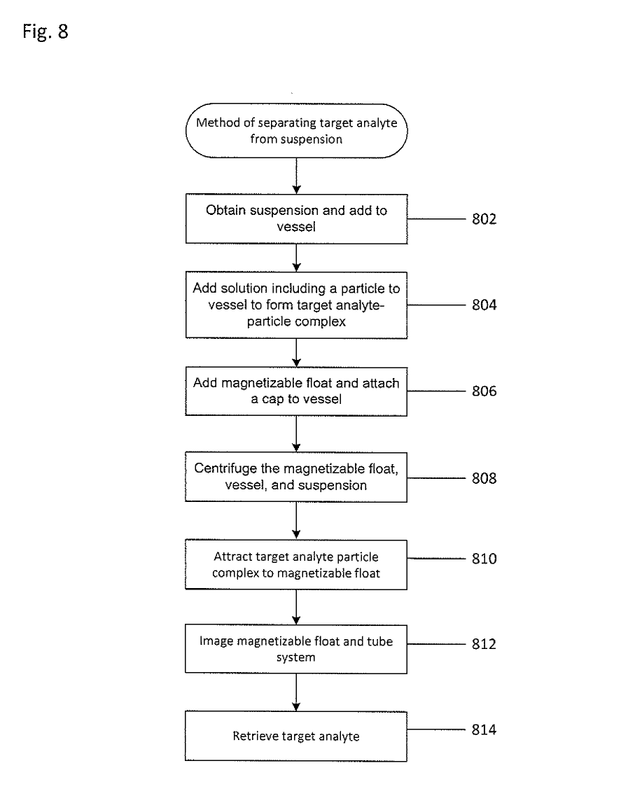

FIG. 8 shows a flow diagram for separating a target analyte from a suspension. In block 802, a suspension is obtained and then added to a vessel, such as a tube. In block 804, a solution including a particle to conjugate to a target analyte to form a target analyte-particle complex is added to the tube and incubated. The target analyte may be conjugated with the particle via direct conjugation, first-degree indirect conjugation, or second-degree indirect conjugation. Alternatively, the solution including the particle may be added to the suspension before the suspension is added to the vessel.

In block 806, a magnetizable float is added to the vessel and a cap seals the vessel. For the sake of convenience, the suspension discussed herein is blood, though the suspension can be urine, blood, bone marrow, cystic fluid, ascites fluid, stool, semen, cerebrospinal fluid, nipple aspirate fluid, saliva, amniotic fluid, vaginal secretions, mucus membrane secretions, aqueous humor, vitreous humor, vomit, and any other physiological fluid or semi-solid. Furthermore, for the sake of convenience, the target analyte discussed herein is a circulating tumor cell (“CTC”), though the target analyte can be a cell, such as ova, a circulating endothelial cell, a vesicle, a liposome, a protein, a nucleic acid, a biological molecule, a naturally occurring or artificially prepared microscopic unit having an enclosed membrane, parasites, microorganisms, viruses, or inflammatory cells.

In block 808, the magnetizable float, the tube, and the suspension undergo density-based separation, such as by centrifugation, thereby permitting separation of the suspension into density-based fractions along an axial position in the tube based on density. In block 810, the target analyte-particle complex is attracted to the magnetizable float after centrifugation. Alternatively, the target analyte-particle complex may be attracted to the magnetizable float during centrifugation.

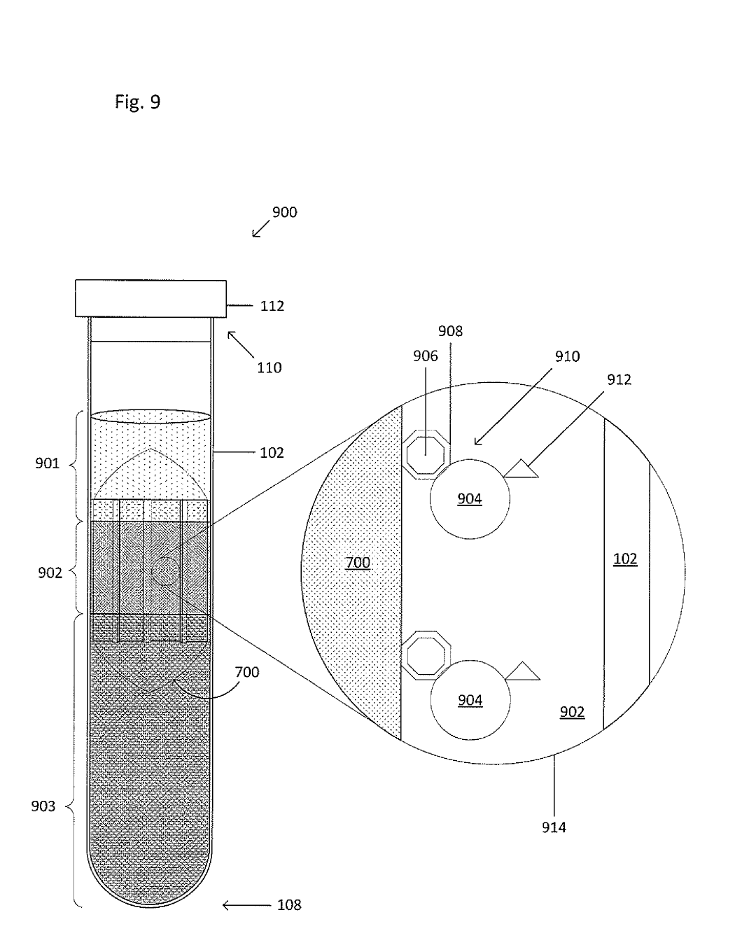

FIGS. 9-11 show isometric views of the tube and float system 900 having undergone density-based separation, such as by centrifugation. Suppose, for example, the suspension includes three fractions. The suspension separates into three fractions, with a highest density fraction 903 located on the bottom, a lowest density fraction 901 located on top, and a medium density fraction 902 located in between. The magnetizable float 700 may have any appropriate density to settle within one of the fractions. The density of the magnetizable float 700 can be selected so that the magnetizable float 700 settles at the same axial position of the target analyte. The target analyte can be trapped within an analysis area between the magnetizable float 700 and the tube 102.

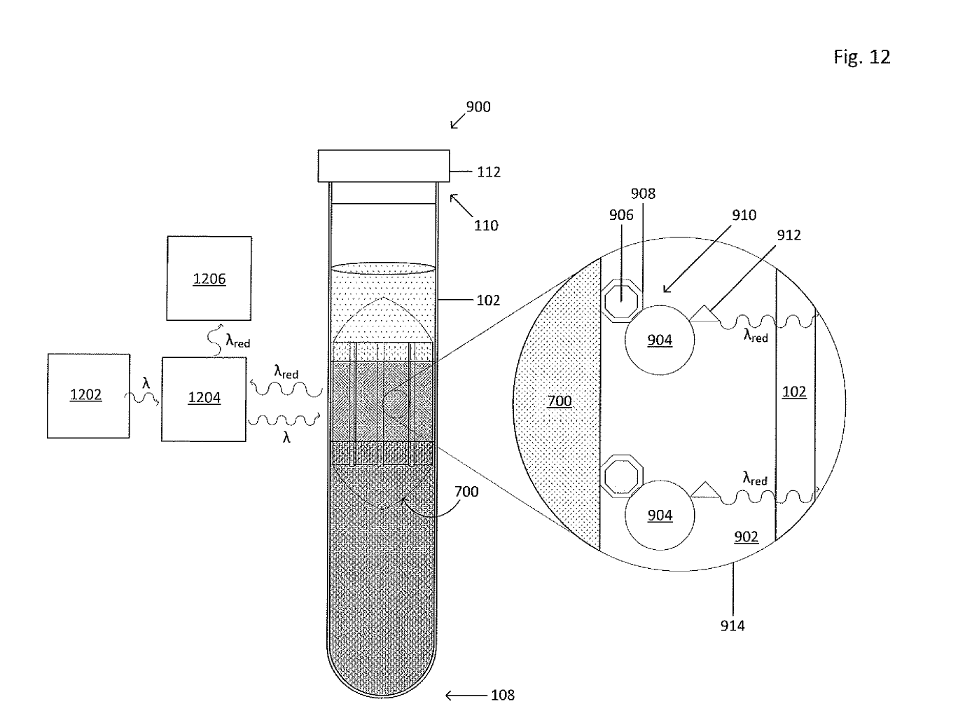

FIG. 9 shows an isometric view of a tube and magnetizable float system 900. The system 900 includes direct conjugation between a target analyte 904 and a particle 906, as shown in magnified view 914. The particle 906 includes a first molecule 908, the first molecule 908 having been coated, bound, or attached to an outer surface of the particle 906. The first molecule 908 is configured to bind directly to a second molecule of the target analyte 904. The first and second molecules are complementary conjugates. These complementary conjugates may bind to each other by covalent, ionic, dipole-dipole interactions, London dispersion forces, Van der Waal's forces, hydrogen bonding, or other chemical bonds. For example, the first molecule may be an EpCAM antibody and the second molecule on the target analyte may be an EpCAM antigen. The EpCAM antibody binds with the EpCAM antigen of the circulating tumor cell, as the EpCAM antibody and the EpCAM antigen are complementary conjugates. Furthermore, the target analyte 904 may be separately labeled with a fluorescent marker 912, as discussed in reference to FIG. 12.

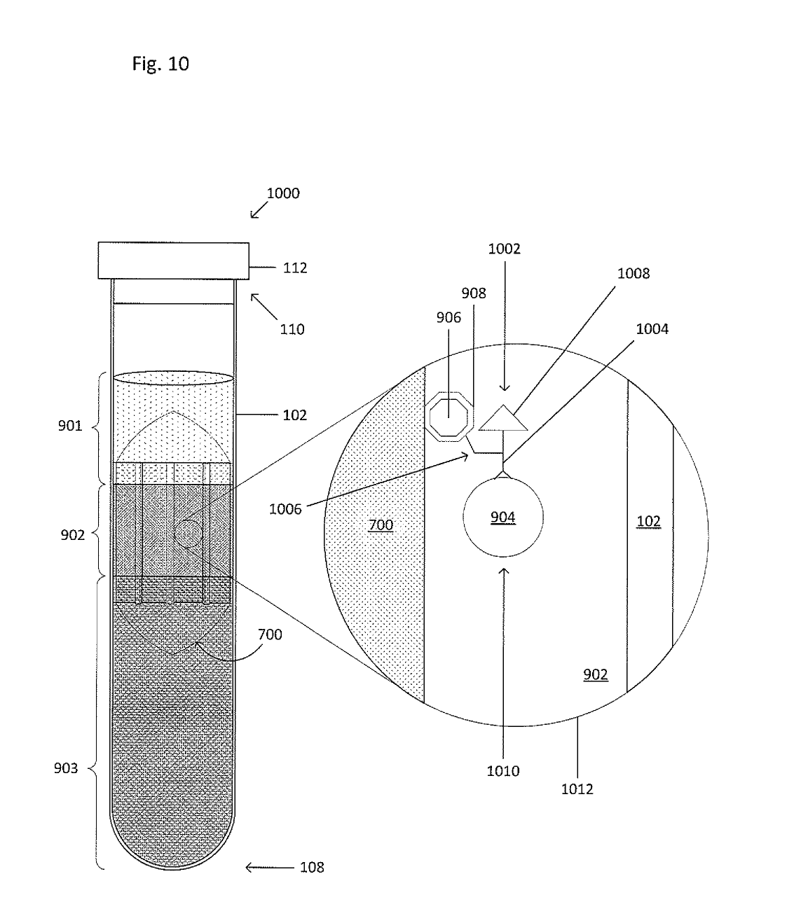

FIG. 10 shows an isometric view of a tube and magnetizable float system 1000. The system 1000 includes first-degree indirect conjugation between the target analyte 904 and the particle 906, as shown in magnified view. For first-degree indirect conjugation, the target analyte 904 is conjugated with the particle 906 via a doubly-conjugated ligand. The particle 906 includes the first molecule 908. The doubly-conjugated ligand 1002 is a ligand 1004 that is “doubly conjugated” as it is bound to two distinct molecules, a second molecule 1006 and a third molecule, such as a fluorescent molecule 1008. The ligand 1004 is a complementary conjugate to a molecule of the target analyte 904. The second molecule 1006 is a complementary conjugate to that of the first molecule 908 such that the first molecule 908 and the second molecule 1102 attract, and may also bind to, each other.

A doubly-conjugated ligand is a ligand which has been conjugated with two distinct molecules, such that the two molecules are not of the same composition or structure. The doubly-conjugated ligand provides a wide range of applications, such as a fluorescent linker between two articles, such that it is conjugated with a fluorescent marker and a distinct molecule so that the fluorescent marker emits a light signal upon excitation. The doubly-conjugated ligand provides a more functional way of linking two or more articles. The doubly-conjugated ligand may also amplify the detectable signal of the labeled article. To doubly conjugate the ligand, an unlabeled ligand may first be added to a reactive solution containing both a reactive first molecule and a reactive second molecule, such that the reactive first and second molecules are not of the same composition or structure. Next, the solution is incubated. The reactive second and third molecules compete for attachment to the unfilled conjugation sites of the ligand, thereby conjugating the ligand with some of the reactive second molecule and some of the reactive third molecule. In order to do this, however, a portion of the molar concentrations of each of the second and third molecules will be used, such that the total molar amount will be the same as when a single labeling reaction were done.

Alternatively, to doubly conjugate a ligand, the ligand may be pre-labeled with the third molecule and then added to a solution comprising the reactive second molecule, such that the third molecule and the reactive second molecule are not of the same composition or structure. Next, the solution is incubated. The reactive second molecule will attach to at least one of the unfilled conjugation sites on the ligand pre-labeled with the third molecule.

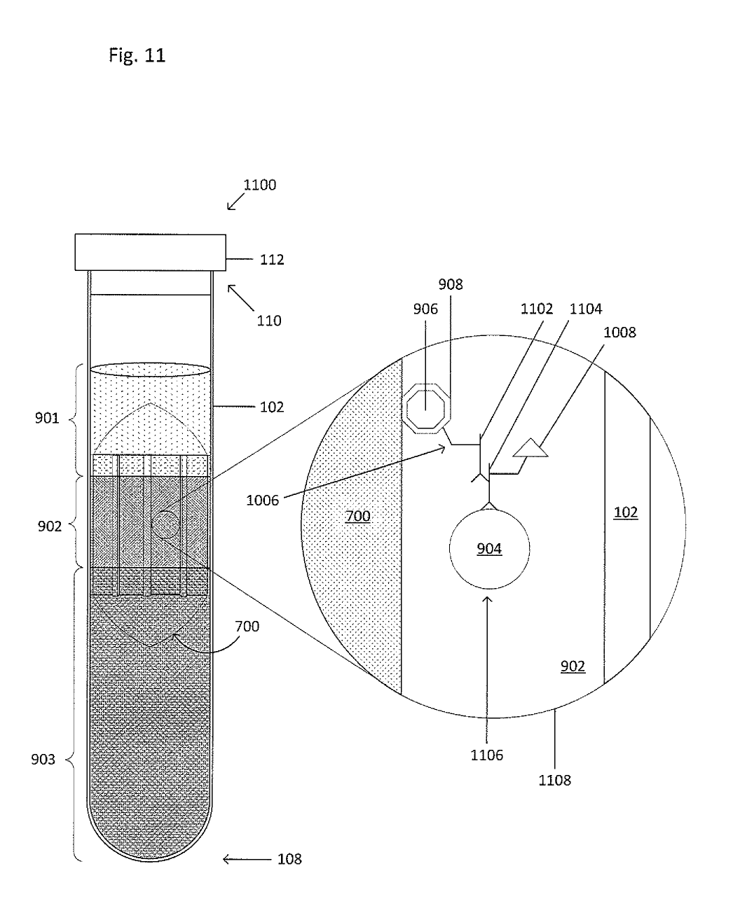

FIG. 11 shows an isometric view of a tube and magnetizable float system 1100. The system 1100 includes second-degree indirect conjugation between the target analyte 904 and the particle 906, as shown in magnified view 1108. The particle 906 includes the first molecule 908. A first intermediary 1102 includes the second molecule 1006. The particle 906 and the first intermediary 1102 bind, as the first and second molecules 908 and 1006 are complementary conjugates. A second intermediary 1104, being bound with the fluorescent molecule 1008, binds with the target analyte 904 and the first intermediary 1102. The first and second intermediaries 1102 and 1104 are complementary conjugates or include complementary conjugates bound thereto. The second intermediary 1104 is a complementary conjugate to a molecule of the target analyte 904.

Regarding FIGS. 9-11, the first and second molecules are complementary conjugates that form a bond with each other, thereby directly or indirectly binding any article to which the first and second molecules are already attached. These complementary conjugates may bind to each other by covalent, ionic, dipole-dipole interactions, London dispersion forces, Van der Waal's forces, hydrogen bonding, or any chemical bond.

The particle may come in any form, including, but not limited to, a bead, a nanoparticle (such as a quantum dot), a shaving, a filing, or the like, such that the particle is capable of being attracted by a magnetic field or magnetic gradient introduced by a magnet. The particle may itself be magnetic, diamagnetic, ferromagnetic, paramagnetic, or superparamagnetic. The particle 1014 may be composed of a variety of different materials including, but not limited to, metals, including, but not limited to, aluminum, brass, gold, silver, tin, copper, bronze, chromium, cobalt, nickel, lead, iron, steel, manganese, zinc, neodymium, and combinations thereof; at least one organic material, at least one inorganic material, at least one mineral, at least one ferrofluid, at least one plastic, at least one polymer and combinations thereof.

Returning to FIG. 8, in block 812, the tube and magnetizable float system may be imaged. FIG. 12 shows an imaging process. To image the tube and magnetizable float system 900 having undergone density-based separation, an analysis area is illuminated with one or more wavelengths of excitation light from a light source 1202, such as red, blue, green, and ultraviolet. A solution containing the fluorescent marker 912 may be used to label the target analyte 904, thereby providing a fluorescent signal for identification and characterization. The solution containing the fluorescent marker 912 may be added to the suspension before the suspension is added to the vessel, after the suspension is added to the vessel but before centrifugation, or after the suspension has undergone centrifugation. The fluorescent marker 912 includes a fluorescent molecule bound to a ligand. The target analyte 904 may have a number of different types of surface markers. Each type of surface marker is a molecule, such an antigen, capable of attaching a particular ligand, such as an antibody. As a result, ligands can be used to classify the target analyte and determine the specific type of target analytes present in the suspension by conjugating ligands that attach to particular surface markers with a particular fluorescent molecule. Examples of suitable fluorescent molecules include, but are not limited to, quantum dots; commercially available dyes, such as fluorescein, FITC (“fluorescein isothiocyanate”), R-phycoerythrin (“PE”), Texas Red, allophycocyanin, Cy5, Cy7, cascade blue, DAPI (“4′,6-diamidino-2-phenylindole”) and TRITC (“tetramethylrhodamine isothiocyanate”); combinations of dyes, such as CY5PE, CY7APC, and CY7PE; and synthesized molecules, such as self-assembling nucleic acid structures. Many solutions may be used, such that each solution includes a different type of fluorescent molecule bound to a different ligand.

The excitation light is focused by an objective 1204 onto the analysis area, which is a space between the magnetizable float and tube in which a target analyte may be retained or trapped. The different wavelengths excite different fluorescent markers, causing the fluorescent markers to emit light at lower energy wavelengths. A portion of the light emitted by the fluorescent markers is captured by the objective 1204 and transmitted to a detector 1206 that generates images that are processed and analyzed by a computer or associated software or programs. The images formed from each of the channels can be overlaid when a plurality of fluorescent markers, having bound themselves to the target analyte, are excited and emit light. The light source 1202 and the objective 1204 may be separate pieces or may be one piece. The light source 1202 and the objective 1204 may be coaxial or may be located on different planes. The target analyte 904 can then be characterized, and its location identified, based on the light emission(s) from the fluorescent marker(s) 912 attached to the target analyte 904.

Returning to FIG. 8, in block 814, the target analyte may be retrieved. To retrieve the target analyte, the magnetizable float may be removed from the tube. Alternatively, the target analyte may be retrieved directly from the tube.

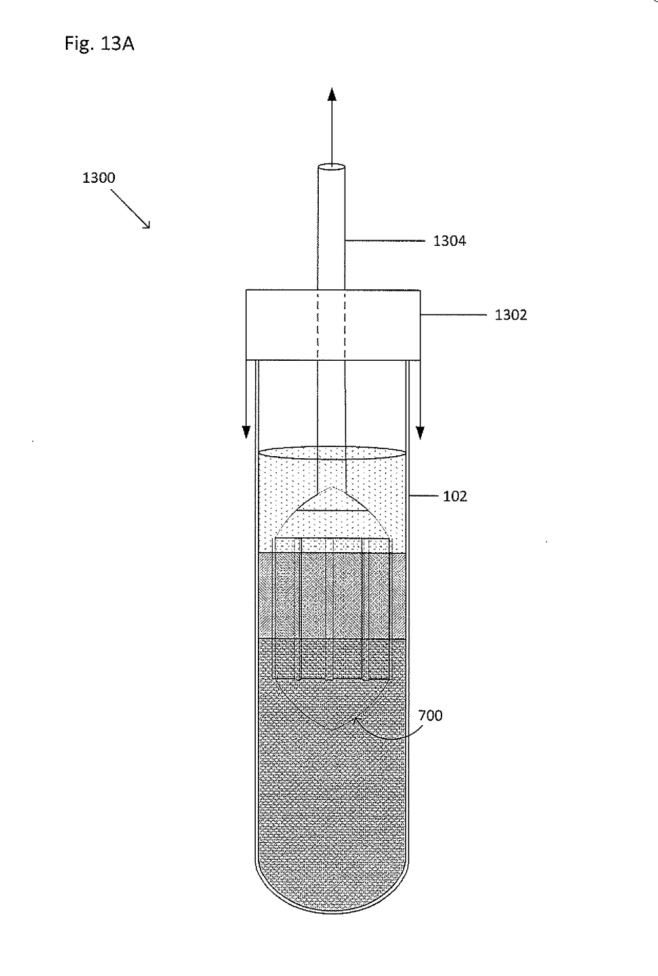

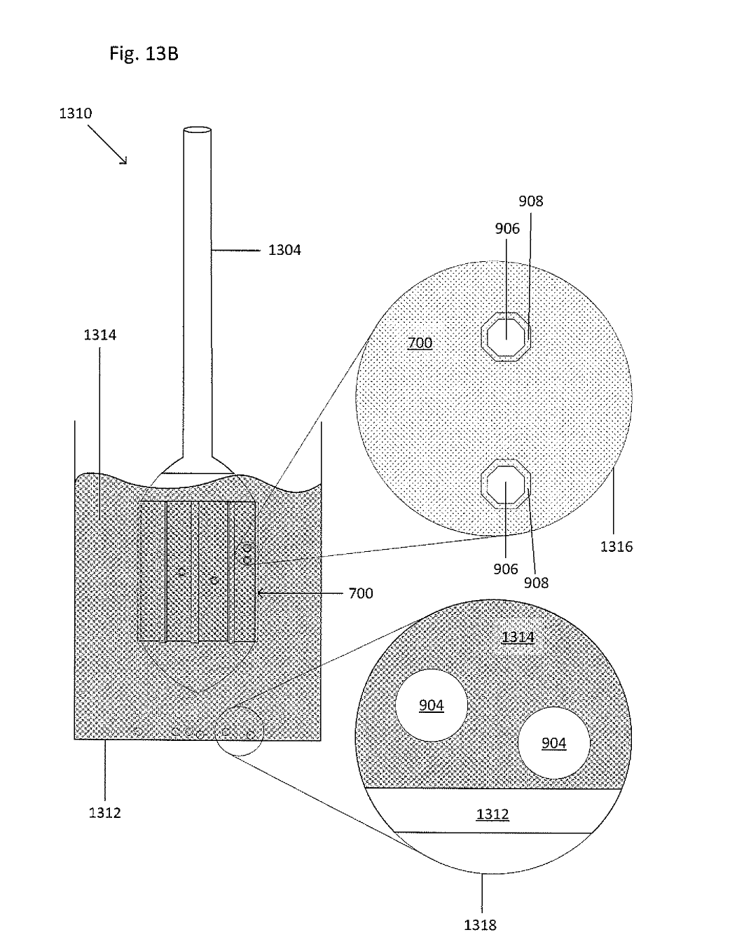

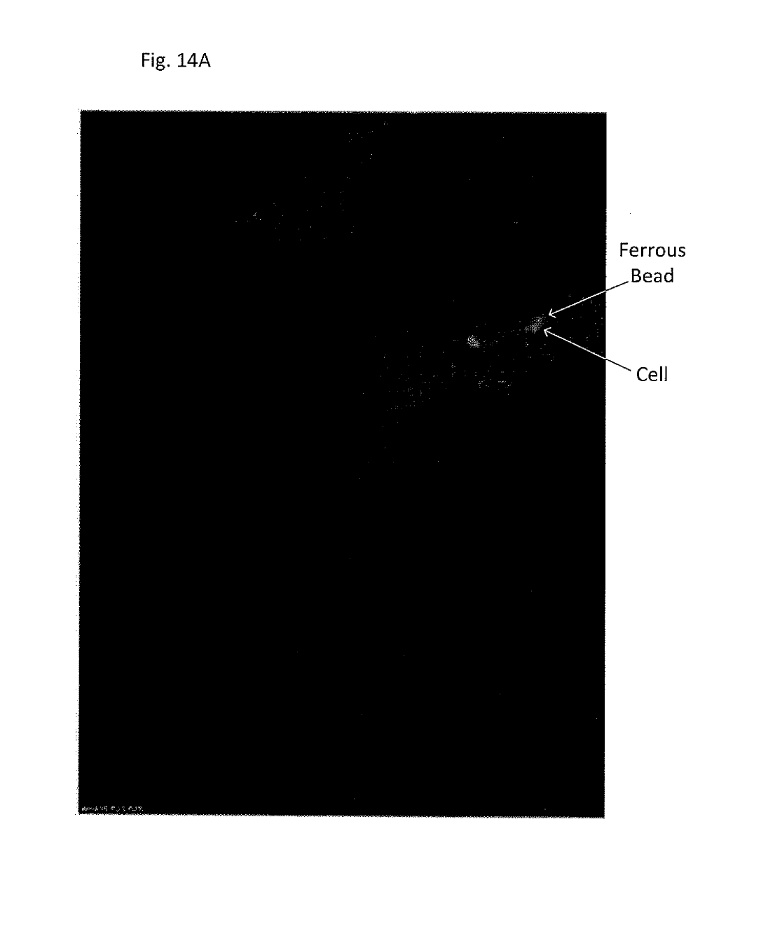

FIG. 13A shows the magnetizable float 700 being removed from the tube 102. To remove the magnetizable float 700 from the tube 102, a weighted object 1302 may be placed on top of the tube 102 to apply an axial load, so to cause the tube 102 to expand, thereby providing clearance to remove the magnetizable float 900 manually or with a removing tool 1304. Alternatively, the tube and magnetizable float system may be inserted into an adapter and a vacuum is then drawn between the tube and the adapter. The pressure differential causes the tube to expand within the adapter. Alternatively, the tube may be separated. The tube may be separated by splitting, bifurcating, pulling apart, cutting, or tearing the tube. After separating the tube, the magnetizable float may be removed.

FIG. 13B shows the target analyte 904 being separated from the particle 906, and ultimately, the magnetizable float 700. The target analyte 904 may be separated from the particle 906 by performing proteolytic or nucleic acid cleavage. The magnetizable float 700 is inserted into a container 1312 including a solution 1314 to cleave the target analyte 904 from the particle 906 by breaking the bond between the target analyte 904 and the particle 906. The particle 906 may still be attracted to the magnetizable float 700 due to the magnetic force. The target analyte 904, however, separates from the particle 906 and then remains in the solution 1314. It may be desirous to separate the target analyte from the particle to remove the target analyte from the magnetizable float (when the target analyte-particle complex is still attracted to the magnetizable float) or to separate the target analyte from the particle after the target analyte-particle complex has been detached from the magnetizable float. Alternatively, pH variation or salt concentration variation (i.e. increasing the salt concentration of the surrounding solution to disrupt the molecular interactions that hold the target analyte to the particle) may be performed to separate the target analyte from the particle.

Alternatively, when the magnetizable float is removed from the tube, a second force may be introduced by an extraction device—such as by a magnet, a pipette, or the like—to remove the target analyte-particle complex from the magnetizable float. The second force may be stronger than the force of the magnetic field or the magnetic gradient, so as to overcome the magnetic force, thereby attracting or pulling the target analyte off of the magnetizable float. The second force may be magnetic, electrical, pressure (such as by suction or a vacuum), or the like.

Alternatively, a dissipating magnetic field or a fluctuating magnetic field with decreasing amplitude may also permit isolation of a target analyte-particle complex, such as one that may be implemented to reduce or eliminate hysteresis. When the magnetic field is temporarily applied (i.e. through the use of a switchable magnet, an electromagnet, or a magnetizable core/coating with a magnetic field being introduced), once the magnetic field is turned off or removed in some manner, the magnetizable float is no longer magnetic and may no longer magnetically attract the particle. After the magnetic field is eliminated or reduced, the magnetizable float may have a residual magnetism, or hysteresis, which will still permit the magnetizable float to magnetically attract certain particles. Hysteresis, however, may be reduced or eliminated by introducing or applying a magnetic field in the opposite direction that of the residual magnetic field. The magnetizable float may be permanently magnetized by adding a magnet to an inner cavity of the magnetizable float, making the magnetizable float out of a magnetic material, or having the outer surface of the magnetizable float comprising at least one magnet. Referring back to the magnetizable float having at least one coil within or around the magnetizable float, the at least one coil may comprise a plurality of smaller coils, each coil thereby producing a smaller magnetic field which may aggregate to form a larger, stronger magnetic field. As the intensity of the magnetic field decreases, more particles will be required to hold the attracted analyte to the magnetizable float. The magnetic field may be denoted as B. The magnetic field has a maximum amplitude, B_{MAX}, and a minimum amplitude, B₀, where B₀ is the point at which the magnetic field is lost, has completely dissipated, or does not exist.

As an example of the number of particles required for attraction versus the amplitude of the magnetic field, an analyte that only has been conjugated with one particle may fall off of the magnetizable float when B at a first time (B_{T1}) is 75% of B_{MAX}, or 0.75B_{MAX}. An analyte that has been conjugated with two particles may fall off when at a second time (B_{T2}) is 60% of B_{MAX}, or 0.60BM_{AX}. An analyte that has been conjugated with three particles may fall off when at a third time (B_{T3}) is 50% of B_{MAX}, or 0.50BM_{AX}. An analyte that has been conjugated with four particles may fall off when at a fourth time (B_{T4}) is 33% of B_{MAX}, or 0.33BM_{AX}. When a specific target analyte has been conjugated with a known number of particles, it may be desirous to wait until the magnetic field is at a level which no longer attracts the conjugate. When the specific target analyte has been conjugated with an unknown number of particles, further analysis may be performed on the conjugate to determine its classification. It should be noted that the numbers and values discussed herein are used to show the principles and may be different in practice or with each conjugation.

To retrieve the target analyte-particle complex from the tube, a hole may be bored through the sidewall of the tube. The hole may be introduced by drilling, cutting, or puncturing the sidewall of the tube at a location where the target analyte is located, as may be determined by imaging. When the hole is formed, the extraction device may be introduced to retrieve the target analyte-particle complex by introducing the second force to overcome the magnetic force of the magnetizable float.

### Biological Applications

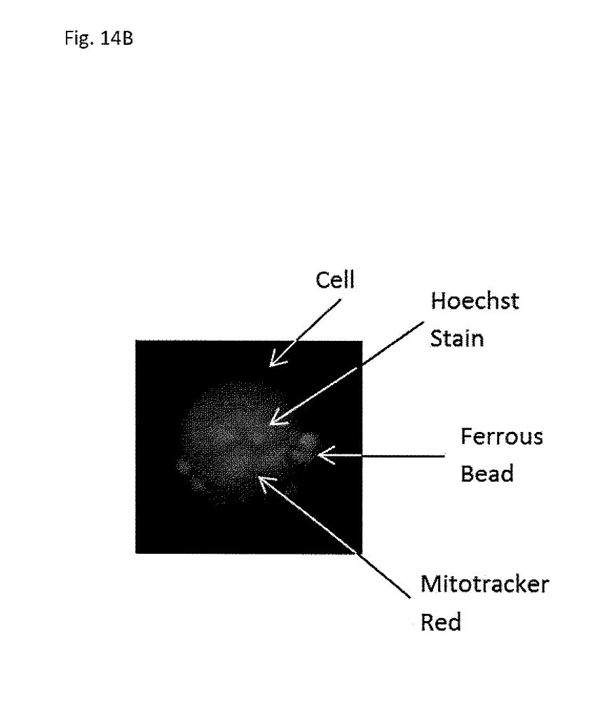

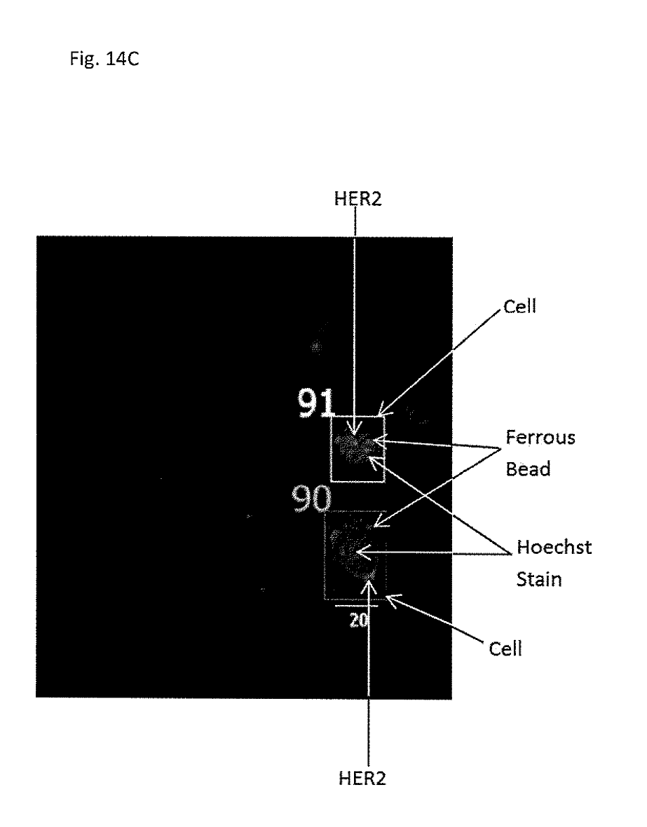

Referring now to FIG. 14A, an image of cells that are labeled with doubly-conjugated ligands and have Hoechst and HER2 staining is presented. The cells, having been pre-labeled with Hoechst and Celltracker™ green, were spiked into a blood sample in a tube and were then labeled with the doubly-conjugated ligands. Streptavidin-coated beads and biotinylated EpCAM antibodies labeled with Alexa Fluor 647 were used. The streptavidin-coated beads bound the biotin molecule of the doubly-conjugated ligand. The EpCAM antibody of the doubly-conjugated ligand bound to an EpCAM antigen on the cell. The tube was then centrifuged with a float. The cells were then imaged for detection and characterization. The Alexa Fluor 647 provided a red fluorescent emission light when excited for detection and characterization.

Referring now to FIGS. 14B and 14C, images of cells that are conjugated with ferrous beads and have Hoechst and MitoTracker® red staining are presented. These images were taken at different stages of the separation method, as shown in FIG. 8. The cells, having been pre-labeled with Hoechst and Mitotracker® red, were spiked into a blood sample in a tube and then conjugated with the ferrous beads. Streptavidin-coated beads and biotinylated EpCAM antibodies were used. The tube was then centrifuged with a float. The plasma was then removed and a magnet was added to the tube, thereby being placed in contact with a top end of the magnetizable float. FIG. 14B shows an image of the cell after centrifugation. FIG. 14C shows an image of the cell after the magnetizable float has been magnetized.

The target analyte may be analyzed using any appropriate analysis method or technique, though more specifically extracellular and intracellular analysis including intracellular protein labeling; nucleic acid analysis, including, but not limited to, DNA arrays, expression arrays, protein arrays, and DNA hybridization arrays; in situ hybridization (“ISH”—a tool for analyzing DNA and/or RNA, such as gene copy number changes); polymer chain reaction (“PCR”); reverse transcription PCR; or branched DNA (“bDNA”—a tool for analyzing DNA and/or RNA, such as mRNA expression levels) analysis. These techniques require fixation, permeabilization, and isolation of the target analyte prior to analysis. Some of the intracellular proteins which may be labeled include, but are not limited to, cytokeratin (“CK”), actin, Arp2/3, coronin, dystrophin, FtsZ, myosin, spectrin, tubulin, collagen, cathepsin D, ALDH, PBGD, Akt1, Akt2, c-myc, caspases, survivin, p27^{kip}, FOXC2, BRAF, Phospho-Akt1 and 2, Phospho-Erk1/2, Erk1/2, P38 MAPK, Vimentin, ER, PgR, PI3K, pFAK, KRAS, ALKH1, Twist', Snail1, ZEB1, Fibronectin, Slug, Ki-67, M30, MAGEA3, phosphorylated receptor kinases, modified histones, chromatin-associated proteins, and MAGE. To fix, permeabilize, or label, fixing agents (such as formaldehyde, formalin, methanol, acetone, paraformaldehyde, or glutaraldehyde), detergents (such as saponin, polyoxyethylene, digitonin, octyl β-glucoside, octyl β-thioglucoside, 1-S-octyl-β-D-thioglucopyranoside, polysorbate-20, CHAPS, CHAPSO, (1,1,3,3-Tetramethylbutyl)phenyl-polyethylene glycol or octylphenol ethylene oxide), or labeling agents (such as fluorescently-labeled antibodies, enzyme-conjugated antibodies, Pap stain, Giemsa stain, or hematoxylin and eosin stain) may be used.

In direct conjugation, the first molecule of the particle bonds directly with the CTC. In first-degree indirect conjugation, the particle having a first molecule is conjugated to the CTC via a doubly-conjugated ligand. The doubly-conjugated ligand is bound to a second molecule and a third molecule. The second molecule is a complementary molecular conjugate to that of the first molecule such that the first molecule and the second molecule bond to each other. In second-degree indirect conjugation, the CTC is conjugated to the particle via the first intermediary particle bound to a second molecule and the fluorescent marker-conjugated second intermediary particle while in the tube or prior to introduction into the tube.

The first molecule of the particle, whether introduced to the particle through binding, coating, or attaching, may include, but is not limited to, an avidin, such as streptavidin or neutravidin; Protein A, Protein G, Protein L; biotin; an aptamer; a primary antibody that binds to biomarkers, including but not limited to, EpCAM, AMACR, Androgen receptor, CD 146, CD227, CD235, CD24, CD30, CD44, CD45, CD56, CD71, CD105, CD324, CD325, MUC1, CEA, cMET, EGFR, Folate receptor, HER2, Mammaglobin, or PSMA; a ligand, such as EGF, HGF, TGFα, TGFβ superfamily of ligands, IGF1, IGF2, Wnt signaling proteins, FGF signaling ligands, amphiregulin, HB-EGF, neuregulin signaling ligands, MSP, VEGF family of ligands, betacellulin, epiregulin, epigen, hedgehog signaling ligands; IgG, IgM; scFv, Fab, sdAb; an antibody-like molecule that binds to a biomarker; or a second antibody.

The first and second molecules are complementary molecular conjugates that will indirectly bind and attach any particle to which they are already attached by binding and attaching to each other. The second molecule may include, but is not limited to, an avidin, such as streptavidin or neutravidin; Protein A, Protein G, Protein L; biotin; an aptamer; a primary antibody that binds to biomarkers, including but not limited to, EpCAM, AMACR, Androgen receptor, CD146, CD227, CD235, CD24, CD30, CD44, CD45, CD56, CD71, CD324, CD325, MUC1, CEA, cMET, EGFR, Folate receptor, HER2, Mammaglobin, or PSMA; a ligand, such as EGF, HGF, TGFα, TGFβ superfamily of ligands, IGF1, IGF2, Wnt signaling proteins, FGF signaling ligands, amphiregulin, HB-EGF, neuregulin signaling ligands, MSP, VEGF family of ligands, betacellulin, epiregulin, epigen, hedgehog signaling ligands; IgG, IgM; scFv, Fab, sdAb; an antibody-like molecule that binds to a biomarker; or a second antibody.

On a doubly-conjugated ligand, the third molecule may include, but is not limited to, a fluorescent marker; alkaline phosphatase; an avidin, such as streptavidin or neutravidin; Protein A, Protein G, Protein L; biotin; an aptamer; a primary antibody that binds to biomarkers, including but not limited to, EpCAM, AMACR, Androgen receptor, CD 146, CD227, CD235, CD24, CD30, CD44, CD45, CD56, CD71, CD105, CD324, CD325, MUC1, CEA, cMET, EGFR, Folate receptor, HER2, Mammaglobin, or PSMA; a ligand, such as EGF, HGF, TGFα, TGFβ superfamily of ligands, IGF1, IGF2, Wnt signaling proteins, FGF signaling ligands, amphiregulin, HB-EGF, neuregulin signaling ligands, MSP, VEGF family of ligands, betacellulin, epiregulin, epigen, hedgehog signaling ligands; IgG, IgM; scFv, Fab, sdAb; an antibody-like molecule that binds to a biomarker; or a second antibody.

The first and second intermediaries may include, but are not limited to an avidin, such streptavidin or neutravidin; biotin; a protein; an antibody, including but not limited to, EpCAM, AMACR, Androgen receptor, CD146, CD227, CD235, CD24, CD30, CD44, CD45, CD56, CD71, CD105, CD324, CD325, MUC1, CEA, cMET, EGFR, Folate receptor, HER2, Mammaglobin, or PSMA; a ligand, such as EGF, HOF, TGFα, TGFβ superfamily of ligands, IGF1, IGF2, Wnt signaling proteins, FGF signaling ligands, amphiregulin, HB-EGF, neuregulin signaling ligands, MSP, VEGF family of ligands, betacellulin, epiregulin, epigen, hedgehog signaling ligands; or an aptamer.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

I/We claim:

1. A magnetizable float, comprising:
a main body,
wherein the main body propagates a magnetic field or a magnetic gradient at least the entire length of the main body, and,
wherein when the main body is magnetized, a target analyte-particle complex is attracted to a surface of the main body.

2. The float of claim 1, wherein the main body is coated with a magnetizable material.

3. The float of claim 1, wherein the main body is composed of a magnetizable material.

4. The float of claim 1, wherein a permanent magnet or an electromagnet is located within the main body.

5. The float of claim 1, the magnetizable float further comprising a coil to fowl an electromagnet when connected to a power supply via a first lead and second lead.

6. The float of claim 5, wherein the coil is on an inside wall of the main body, on the outside of an outer wall of the main body, or is embedded within the main body.

7. A system for separating a target analyte from a suspension, the system comprising:
a tube having an open end to receive the suspension; and,
a magnetizable float to be inserted within the tube, the magnetizable float comprising:
a main body,
wherein the main body propagates a magnetic field or a magnetic gradient
at least the entire length of the main body, and,
wherein when the main body is magnetized, a target analyte-particle
complex is attracted to a surface of the main body.

8. The system of claim 7, wherein the main body is coated with a magnetizable material.

9. The system of claim 7, wherein the main body is composed of a magnetizable material.

10. The system of claim 7, the main body further comprising a central bore and a magnetizable core, wherein the magnetizable core is sized and shaped to fit within the central bore.

11. The system of claim 10, wherein the magnetizable core is a permanent magnet.

12. The system of claim 7, the main body further comprising a central bore and an electromagnet, the electromagnet sized and shaped to fit within the central bore.

13. The system of claim 7, wherein a permanent magnet is embedded within the main body.

14. The system of claim 7, further comprising, a solution containing a particle to conjugate with the target analyte to fowl the target analyte-particle complex, wherein when the magnetizable float is magnetized, the target analyte-particle complex is attracted to a surface of the magnetizable float.

15. The system of claim 7, further comprising an electromagnet external to the tube, wherein the electromagnet comprises a power supply, a first lead, a second lead, and a coil, and wherein the coil is in axial alignment with the magnetizable float.

16. A method for separating a target analyte from a suspension, the method comprising:
introducing a solution to a tube containing the suspension and the target analyte, wherein the solution contains a particle that conjugates with the target analyte to form a target analyte-article complex;
introducing a magnetizable float to the tube;
centrifuging the tube and the magnetizable float to effect a density-based separation of the suspension; and
magnetizing the magnetizable float to attract the target analyte-particle complex to a surface of the magnetizable float.

17. The method of claim 16, further comprising removing the magnetizable float from the tube.

18. The method of claim 17, further comprising separating the target analyte from the magnetizable float.

19. The method of claim 16, wherein the magnetizable float is magnetized by a magnet within the main body or by a magnet external to the main body.

20. The method of claim 16, further comprising applying a stimulus to stimulate fluorescence from at least one fluorescently labeled target analyte of the suspension.
